(19) United States
(12) Patent Application Publication
(10) Pub. No.: US 2012/0000081 A1
(43) Pub. Date: Jan. 5, 2012

(54) ENGRAVING NEEDLE HOLDER AND SEWING MACHINE PROVIDED THEREWITH

(75) Inventors: YASUHIKO KAWAGUCHI, Nagoya-shi (JP); RINO NAKAMA, Konan-shi, Aichi-ken (JP); NOBORU MIZUNO, Nagoya-shi (JP); TOMOYASU NIIZEKI, Ichinomiya-shi (JP)

(73) Assignee: BROTHER KOGYO KABUSHIKI KAISHA, Nagoya-shi (JP)

(21) Appl. No.: 13/106,455

(22) Filed: May 12, 2011

(30) Foreign Application Priority Data
Jul. 1, 2010 (JP) 2010-150992

(51) Int. Cl. B43L 13/00

(52) U.S. Cl. 33/18.1

(57) ABSTRACT

An engraving needle holder is disclosed which mounts an engraving needle to a needle bar when an engraving process is executed for a workpiece by moving the engraving needle upward and downward by making use of drive of the needle bar provided on a sewing machine. The engraving needle holder includes a mounted part which is mountable to a fixing part of a lower end of the needle bar into which a handle of the needle is inserted to be fixed, with the needle being removed, a supporting member located at a lower end side of the mounting part so that a base of the engraving needle is mounted to it so as to be positionally adjustable, and an adjusting mechanism which adjusts a mounting height position of the engraving needle relative to the supporting member.

### CROSS-REFERENCE TO RELATED APPLICATIONS

This application is based upon and claims the benefit of priority from the prior Japanese Patent Application No. 2010-150992 filed on Jul. 1, 2010, the entire contents of which are incorporated herein by reference.

### BACKGROUND

1. Technical Field

The present disclosure relates to an engraving needle holder which mounts an engraving needle to a needle bar provided in a sewing machine and a sewing machine provided with the engraving needle holder.

2. Related Art

There has conventionally been provided a multineedle embroidery sewing machine which can continuously execute embroidery sewing with the use of multicolor embroidery threads, for example. The embroidery sewing machine of this type is provided with a needle bar case which is mounted on a distal end of an arm and has, for example, six needle bars. One of the needle bars is selectively coupled to a needle bar driving mechanism thereby to be vertically driven. The embroidery sewing machine is also provided with a transfer mechanism which transfers an embroidery frame holding a workpiece cloth. A control device of the embroidery sewing machine controls the needle bar driving mechanism and other driving mechanisms while moving the embroidery frame holding the workpiece cloth in two or X and Y directions by the transfer mechanism based on pattern data indicative of a needle location per stitch (an amount of movement of the workpiece cloth), color change and the like, thereby executing a multi-color embroidery sewing operation.

The embroidery sewing machine of this type includes one provided with a boring device which makes a cut or bores a hole in the workpiece cloth. The boring device comprises a mount, a holder, a boring knife, a presser and a spring. The boring knife has a lower end formed with a blade portion. A user attaches the boring device to a specific needle bar and starts the operation of the embroidery sewing machine. As a result, eyelet embroidery is executable in which embroidery is made around a cut while the cut or the hole is being formed in the workpiece cloth. Furthermore, the embroidery sewing machine includes a type in which the boring knife is interchangeable with a sewing needle. The needle bar has a lower end formed with an insertion hole into which an upper end of the needle is inserted so that the needle is attached to the needle bar. The upper end of the boring knife has the same configuration as the upper end of the needle. Thus, the upper end of the boring knife is inserted into the insertion hole such that the boring knife is attached to the needle bar.

On the other hand, a plurality of dents (embossment) or small holes has recently been formed in a sheet-like workpiece such as paper in a handicraft field, so that various types of patterns have been expressed using the dents or small holes. For example, a parchment craft has been becoming popular in which a plurality of dents or small holes is formed in thick tracing paper, which is formed into a decor. In this case, only the dents become cloudy when formed in the tracing paper. Patterns are made by utilizing the cloudy dents.

The inventors contemplated using a multineedle sewing machine as an apparatus which executes an engraving process to form the aforesaid dents or small holes by attaching an engraving needle for parchment craft, instead of the sewing needle. In this case, a user attaches to a transfer mechanism a holder to fixedly hold the sheet-like workpiece such as tracing paper, instead of an embroidery frame holding workpiece cloth. The user then vertically moves the needle bar with the attached engraving needle while the holder holding the workpiece is transferred by the transfer mechanism based on previously generated data for engraving process, whereby a predetermined engraving process is applied to the surface of the workpiece. Thus, various patterns each comprising a plurality of engraved marks (dents) or small holes would be considered to be made.

The construction that the engraving needle is detachably attachable to the needle bar is required when the engraving process such as parchment craft or the like is executed by utilizing drive of the needle bar provided in the sewing machine. Furthermore, a depth of engraving in the workpiece changes depending upon a mounting height position of the engraving needle attached to the needle bar. More specifically, the size of the engraved marks (dents) or small holes to be formed on the workpiece changes. Accordingly, it has been sought that the mounting height position of the engraving needle attached to the needle bar should be easily adjustable by the user.

In this case, the boring knife mounting structure can be considered to be applied to the mounting of the engraving needle. However, a needle clamp is attached to the needle to fix the needle attached to the lower end of the needle bar. The needle clamp needs to be detached when the boring device is to be mounted. Attachment and detachment of the needle clamp take a lot of trouble. Furthermore, adjustment of the mounting height position of the boring knife to be attached to the needle bar is not considered, and the mounting height position of the boring knife cannot substantially be adjusted.

### SUMMARY

Therefore, an object of the disclosure is to provide an engraving needle holder which can easily mount the engraving needle to the needle bar of the sewing machine and which can easily adjust the mounting height position of the engraving needle to be mounted, and to provide a sewing machine with the engraving needle holding device.

The present disclosure provides an engraving needle holder which mounts an engraving needle to a needle bar when an engraving process is executed for a workpiece by moving the engraving needle upward and downward by making use of drive of the needle bar provided on a sewing machine, the engraving needle holder comprising a mounted part which is mountable to a fixing part of a lower end of the needle bar into which a handle of the needle is inserted to be fixed, with the needle being removed; a supporting member provided at a lower end side of the mounting part so that a base of the engraving needle is mounted thereto so as to be positionally adjustable; and an adjusting mechanism which adjusts a mounting height position of the engraving needle relative to the supporting member.

The disclosure also provides a sewing machine comprising a needle bar; and an engraving needle holder which mounts an engraving needle to the needle bar when the engraving needle is moved upward and downward by making use of drive of the needle bar so that an engraving process is executed for a workpiece, the engraving needle holder including a mounted part which is mountable to a fixing part of a lower end of the needle bar into which a handle of the needle is inserted to be fixed, with the needle being removed; a supporting member provided at a lower end side of the mounting part so that a base of the engraving needle is mounted thereto so as to be positionally adjustable; and an adjusting mechanism which adjusts a mounting height position of the engraving needle relative to the supporting member.

### BRIEF DESCRIPTION OF THE DRAWINGS

FIG. 1 is a perspective view of the multineedle embroidery sewing machine in accordance with one embodiment;

FIG. 2 is a front view of a needle bar case;

FIGS. 3A, 3B and 3C are front, left side and plan views of the engraving needle holder respectively;

FIG. 4 is an exploded left side view of the engraving needle holding device;

FIG. 5A is a front view of the engraving needle holder, showing adjustment of the height of the engraving needle in the case where the engraving needle is attached to an upper side;

FIG. 5B is a front view of the engraving needle holder, showing adjustment of the height of the engraving needle in the case where the engraving needle is attached to a lower side;

FIG. 6 is a plan view of the frame holder with the embroidery frame being attached;

FIGS. 7A and 7B are plan and longitudinally sectional front view of the engraving holder respectively;

FIG. 8 is a schematic block diagram showing an electrical arrangement of the multineedle embroidery sewing machine;

FIG. 9 is a plan view showing an example of engraved pattern formed on the workpiece;

FIGS. 10A and 10B show two types of engraving needles which differ from each other in the configuration of the distal end; and

FIGS. 11A, 11B and 11C are views similar to FIGS. 3A to 3C respectively, showing a second embodiment.

### DETAILED DESCRIPTION

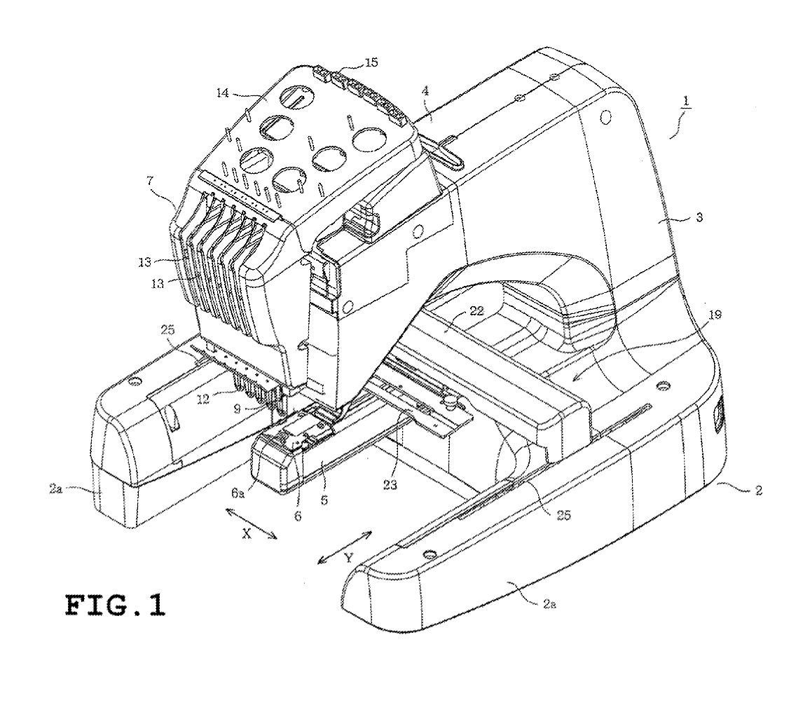

A first embodiment will be described with reference to FIGS. 1 to 10B. A multineedle sewing machine is provided with an engraving needle holder in the embodiment. Referring to FIG. 1, the construction of a multineedle embroidery sewing machine is shown. In the following description, the right-left direction of a sewing machine body 1 will be referred to as “X direction” and the front-back direction thereof will be referred to as “Y direction” as shown in FIGS. 1, 2 and 6.

The multineedle embroidery sewing machine 1 includes a support base 2 placed on a mounting base which is not shown, a pillar 3 extending upward from a rear end of the support base 2 and an arm 4 extending frontward from an upper end of the pillar 3. The support base 2 is formed into substantially a U-shape and has two legs 2a extending forward from right and left portions thereof respectively and an open front as viewed from above. The support base 2 further has a cylinder bed 5 which is formed integrally therewith and extends forward from the central rear thereof. A needle plate 6 having a needle hole 6a is detachably mounted on an upper part of the distal end of the cylinder bed 5. A thread hook is provided in the cylinder bed 5 although not shown.

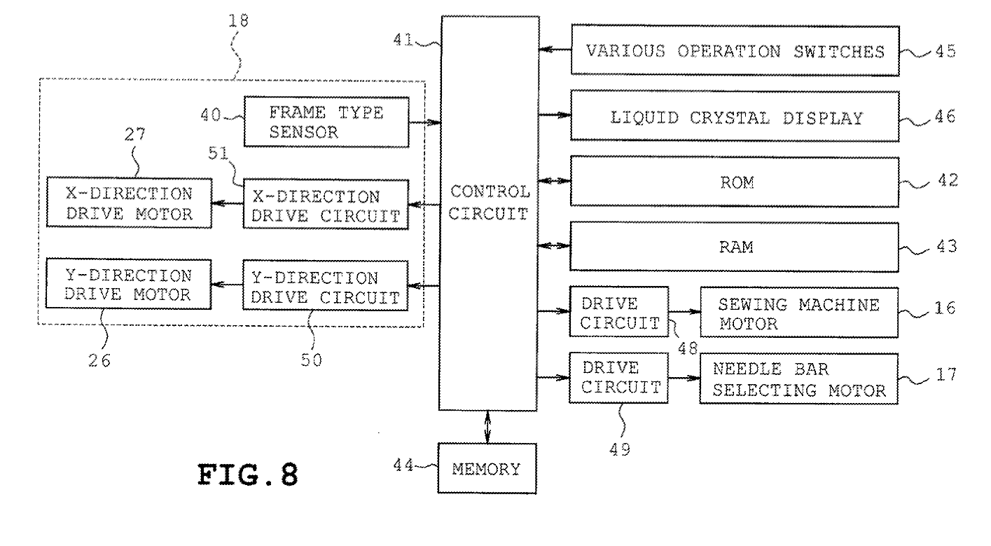

A spool device on which, for example, six thread spools are settable is mounted on an upper rear of the arm 4 although not shown. An operation panel is provided on the right of the arm 4 although not shown. On the operation panel are provided a plurality of operation switches 45 which are operated by the user or operator for operation of various instructions, selection and input and a liquid crystal display (LCD) 46 as shown in FIG. 8.

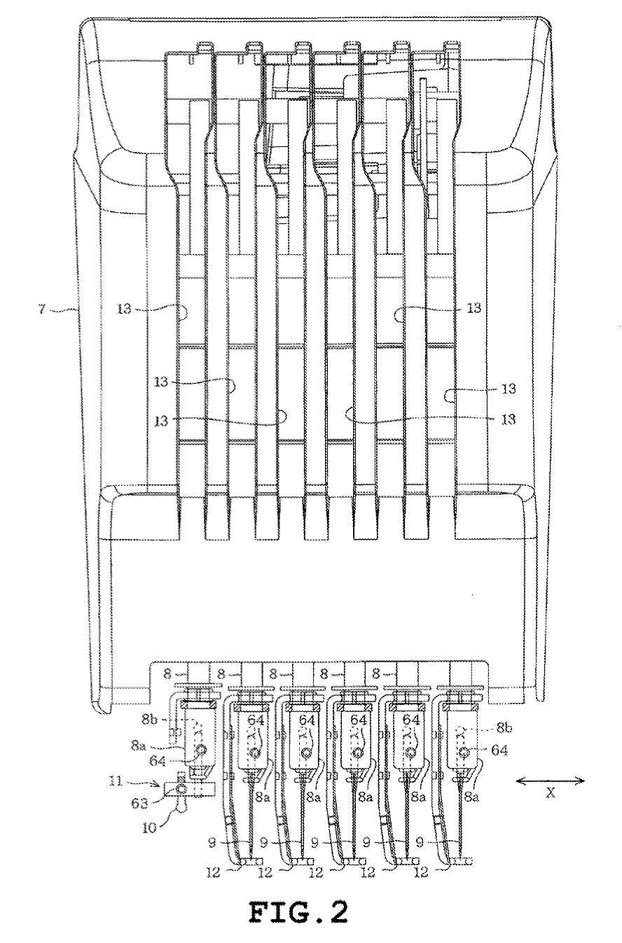

A needle bar case 7 is mounted on a distal end of the arm 4 so as to be movable in the right-left direction (the X direction) as shown in FIGS. 1 and 2. The needle bar case 7 is formed into the shape of a generally rectangular box that is thin in the front-back direction as shown in FIG. 2. A plurality of, for example, six needle bars 8 which are lined up in the right-left direction are movable upward and downward. Each needle bar 8 is normally urged upward by a coil spring that is not shown thereby to be held at a needle-up position as shown in FIG. 2.

The needle bars 8 have lower ends protruding below the needle bar case 7 respectively. Needles 9 for embroidery sewing are detachably or replaceably mounted to the lower ends of the needle bars 8 respectively. Needle clamps 8a are fixed to the lower ends of the needle bars 8 respectively as shown in FIG. 2. Upper handles of the needles 9 are adapted to be attached to the respective needle clamps 8a. The needle clamps 8a serve as fixing parts. The needle clamps 8a have respective holes into which the handles of the needles 9 are inserted from below although the holes are not shown in the drawings. Each handle has a cylindrical shape with a flat part or is formed into a D-cut shape. The needle clamps 8a have the holes formed into such a D-cut shape that the handles of the needle bars 9 are fittable thereinto, respectively. The holes of the needle clamps 8a include upper portions provided with stoppers 8b respectively. The handles of the needles 9 have upper ends which are inserted into the holes until abutting against the stoppers 8a, whereby vertical mounting height positions of the needle bars 9 are determined, respectively. The needle clamps 8a have front portions provided with setscrews 64 for fixing the handles of the needles 9, respectively. The setscrews 64 have respective hexagon sockets. The user uses a tool such as a hex key to tighten or loosen the hexagon sockets, whereby the needles 9 can be attached to and detached from the needle bars 8 respectively.

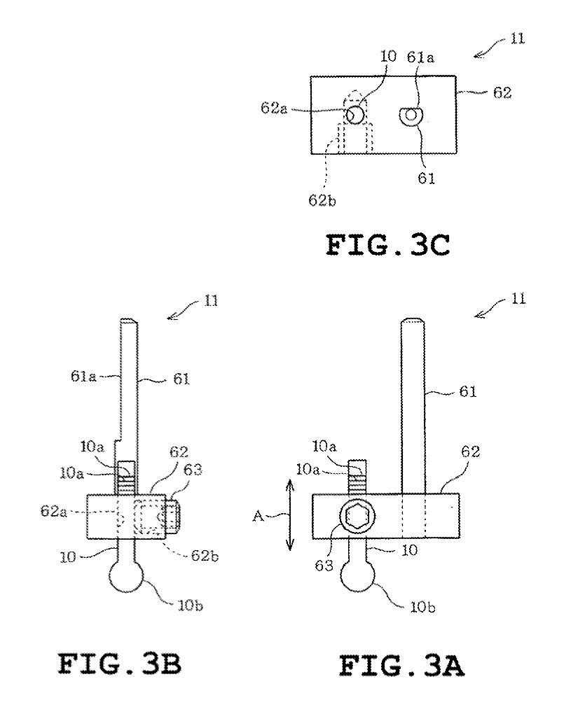

The six needle bars 8 are assigned with needle bar numbers sequentially from right to left. The needle bar numbers will hereinafter be used when specific one or more needle bars are to be designated, and otherwise, reference numeral “8” will be used. In this case, as shown in FIG. 3, an engraving needle holder 11 provided with an engraving needle 10, instead of the needle 9 is attached to the leftmost needle bar No. 6. The engraving needle holder 11 will be described in detail later.

Presser feet 12 are mounted on lower portions of the needle bars 8 so as to be movable upward and downward in synchronization with the upward and downward movement of the needle bars 8 respectively. The presser foot 12 is detached from the needle bar No. 6 since the engraving needle holder 11 is to be attached to the needle bar No. 6. Furthermore, six thread take-up levers are also mounted on an upper portion of the needle bar case 7 so as to correspond to the needle bars 8 respectively although not shown in detail. The needle bar case 7 has six slits 13 which are formed in the front thereof so as to extend vertically. The thread take-up levers have distal ends which are inserted through the slits 13 to protrude to the front side, respectively. The thread take-up levers are configured to be moved upward and downward (swung) in synchronization with the upward and downward movement of the needle bars 8 respectively.

The needle bar case 7 includes an upper cover 14 which is formed integrally therewith and extends obliquely rearward from an upper end thereof as shown in FIG. 1. Six thread tensioners (only mounting holes therefor are shown) and six thread guides 15 are located on an upper end of the upper cover 13. As the result of the above-described construction, needle threads for embroidery sewing are drawn from respective thread spools set on a spool device and passed through respective thread guides 15, the thread tensioners, the thread take-up levers and the like sequentially. The needle threads are finally passed through the eyes of the needles 9 respectively, whereupon the embroidery sewing is executable. In this case, when different colors of needle threads are supplied to five needles 9 of needle bar Nos. 1 to 5, an embroidery sewing operation can continuously be carried out while the threads are automatically changed.

A sewing machine motor 16 (only shown in FIG. 8) is provided in the pillar 3 although not shown in detail in the drawings. In the arm 4 are provided a main shaft 16 driven by the sewing machine motor 16, a needle bar driving mechanism which is driven by rotation of the main shaft 16 thereby to move the needle bars 8 and the like upward and downward, a needle bar selecting mechanism which moves the needle bar case 7 in the X direction to select one of the needle bars 8, and the like, as well known in the art. Additionally, the thread hook is also driven by rotation of the main shaft in synchronization with the upward and downward movement of the needle bar 8.

The needle bar driving mechanism includes an upward and downward moving member which is selectively engaged with the needle bar clamp (not shown) provided on each needle bar 8. The needle bar selecting mechanism is driven by a needle bar selecting motor 17 (shown only in FIG. 8) to transfer the needle bar case 7 in the X direction so that any one of the needle bars 8 located right above the needle hole 6a is engaged with the upward and downward moving member. Additionally, the needle bars 8 are adapted to be reciprocally moved in the upward and downward directions upon one turn of the main shaft.

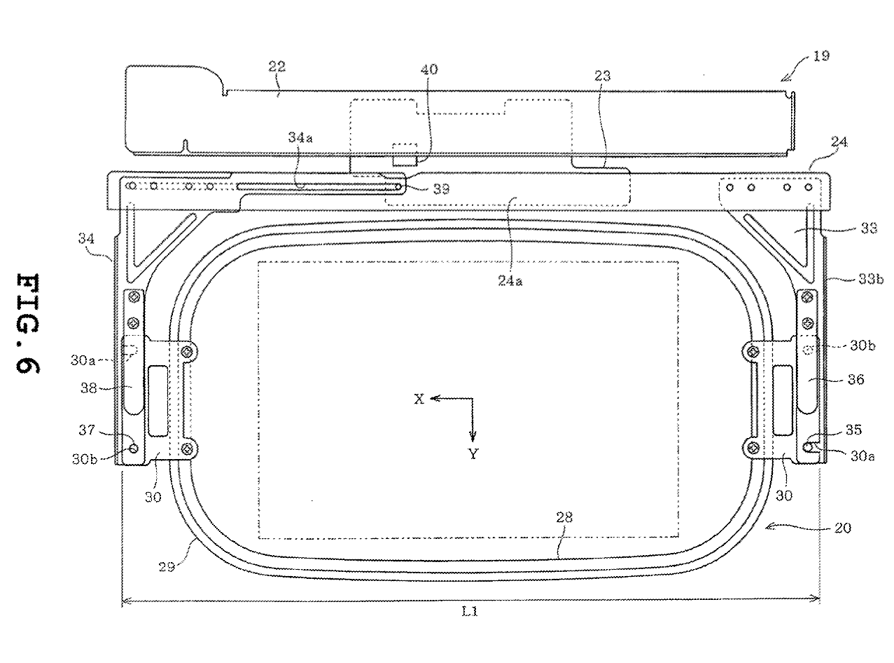

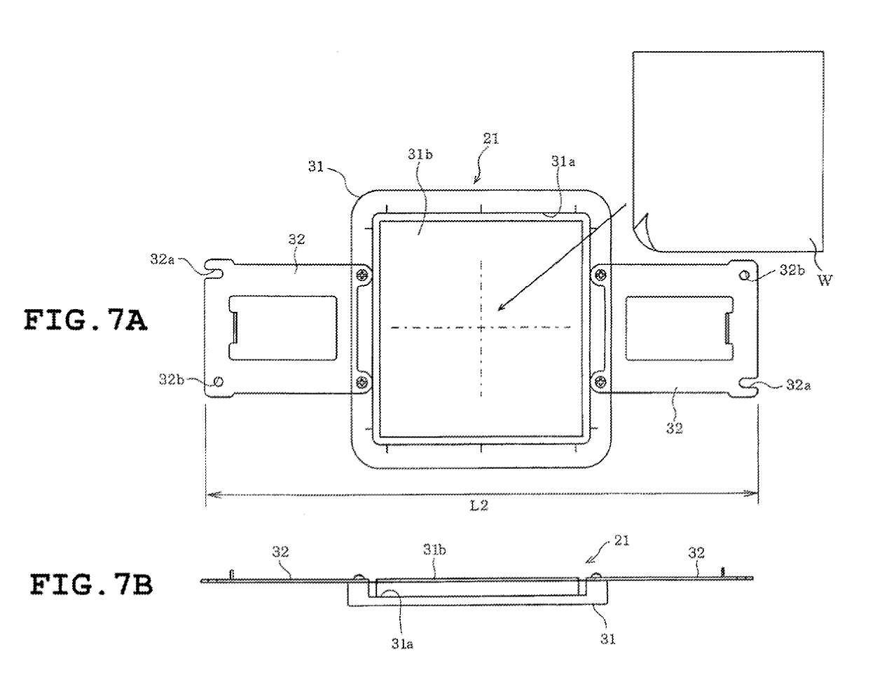

The transfer mechanism 18 (see FIG. 8) includes a carriage 19 located on the upper portion of the cylinder bed 5, as shown in FIG. 1. To the carriage 19 are detachably coupled an embroidery frame 20 (see FIG. 6) holding a workpiece on which embroidery is to be sewn or a engraving support 21 (see FIGS. 7A and 7B) holding the sheet-like workpiece W such as tracing paper for the engraving process as will be described later. A plurality of types of embroidery frames 20 holding the workpiece and differing in the size or shape is provided as accessories although not shown in detail.

The carriage 19 includes a Y-direction carriage 22, an X-direction carriage 23 mounted on the Y-direction carriage 22 and a frame holder 24 (shown only in FIG. 6) mounted on the X-direction carriage 23 as shown in FIGS. 1 and 6. The aforesaid transfer mechanism 18 includes a Y-direction drive mechanism which is provided in the support base 2 to move the Y-direction carriage 22 in the Y direction (the front-back direction) and an X-direction drive mechanism which is provided in the Y-direction carriage 22 to move the X-direction carriage 23 and the frame holder 24 in the X-direction (right-left direction). The embroidery frame 20 or an engraving support 21 is held by the frame holder 24 and is transferred in predetermined two directions or the X and Y directions by the transfer mechanism 18.

The Y-direction carriage 22 is formed into the shape of a horizontally long (narrow) box and extends in the right-left direction (the X direction) so as to bridge between the right and left legs 2a. In this case, the legs 2a of the support base 2 are formed with respective guide grooves 25 extending in the front-back direction (the Y direction) as shown in FIG. 1. The Y-direction drive mechanism includes two moving members which extend vertically through the guide grooves 25 and are provided so as to be movable in the Y-direction (the front-back direction) along the guide grooves 25, respectively, although not shown in the drawings. The Y-direction carriage 22 has right and left ends connected to upper ends of the moving members respectively.

The Y-direction drive mechanism includes a Y-direction drive motor 26 (see FIG. 8) comprising a stepping motor and a linear moving mechanism comprising a timing pulley and a timing belt. The moving member is moved by the linear moving mechanism driven by the Y-direction drive motor serving as a drive source, whereby the Y-direction carriage 22 is moved in the Y direction.

The X-direction carriage 23 is formed into the shape of a horizontally long plate having a part thereof protruding forward from the lower front of the Y-direction carriage 22 as shown in FIGS. 1 and 6. The X-direction carriage 23 is supported by the Y-direction carriage 22 so as to be slidable in the X direction (the right-left direction). The X-direction drive mechanism provided in the Y-direction carriage 22 includes an X-direction drive motor 27 (see FIG. 8) comprising a stepping motor and a linear moving mechanism comprising a timing pulley and a timing belt. The X-direction drive mechanism moves the X-direction carriage 23 in the X direction (right-left direction).

The following describes the frame holder 24 mounted on the X-direction carriage 23, the embroidery frame 20 and the engraving support 21 latter both detachably attached to the frame holder 24. Firstly, the embroidery frame 20 will be described with reference to FIG. 6. The embroidery frame 20 includes a rounded rectangular inner frame 28, an outer frame 29 detachably fitted with the outer periphery of the inner frame 28 and a pair of connecting portions 30 mounted on right and left ends of the inner frame 28. The workpiece cloth serving as the workpiece is held between the inner and outer frames 28 and 29 so as to be held in a stretched state inside the inner frame 28 although not shown in the drawings.

The paired connecting portions 30 have rotational symmetry through 180 degrees in a plan view. The connecting portions 30 are formed with engagement grooves 30a and engagement holes 30b for attachment to the frame holder 24 respectively. A plurality of types of embroidery frames 20 differing in the size and shape (embroidery area) from one another are prepared and selectively used according to a size of embroidery pattern, as described above. Furthermore, the width L1 or the dimension between the outer edges of the connecting portions 30 is set so as to differ from one embroidery frame to another according to the type of the connecting portion 30. The width of the embroidery frame 20 is detected by a detection unit which will be described later, whereby the type of the embroidery frame 20 attached to the frame holder 24 is detected. FIG. 6 shows an embroidery frame 20 having a largest width L1. Additionally, detection is also executed by the aforesaid detection unit when the engraving support 21 is attached to the frame holder 24 as will be described later.

The engraving support 21 will now be described. The engraving support 21 includes a rectangular plate-shaped holding portion 31 having rounded corners and a pair of connecting members 32 attached to right and left ends of the holding portion 31 respectively, as shown in FIGS. 7A and 7B. The holding portion 31 has a bottomed holding recess 31a which is located at the underside of the holding portion 31 and is rectangular in shape except for a peripheral frame-shaped portion. An elastic member 31b is provided in the holding recess 31a. The elastic member 31b is made of a material such as a foamable resin or rubber and formed into a rectangular thin plate shape. The workpiece W such as tracing paper is previously cut into a rectangular plate-shape according to the holding recess 31a. The workpiece W is placed on an upper surface of the elastic member 31b to be fixed by a fixing unit such as a double-side adhesive tape.

The paired connecting portions 32 have rotational symmetry through 180 degrees in a plan view. Each connecting portion 32 is formed with an engagement groove 32a and an engagement hole 32b for attachment to the frame holder 24. The horizontal width L2 of the engraving support 21 is set so as to differ from the width L1 of each type of embroidery frame 20 as described above. Additionally, a plurality of types of engraving supports 21 may be provided according to the size, shape, thickness or the like of the engraved workpiece W.

The frame holder 24 to which the embroidery frame 20 or the engraving support 21 is attached or connected will be described as follows. The frame holder 24 is fixedly mounted on an upper surface of the X-direction carriage 23 as shown in FIG. 6. The frame holder 24 includes a fixedly mounted fixed arm 33 and a movable arm 34 which is mounted on the frame holder 24 so as to be displaceable relative to the frame holder 24. The position of the movable arm 34 changed in the right-left direction by the user according to the types of the embroidery frame 20 and the engraving support 21, that is, the width L1 or L2.

The frame holder 24 formed into the shape of a plate extending in the X direction includes a main part 24a having a right end further having an upper surface on which the fixed arm 33 is mounted so as to be laid on the upper surface. The fixed arm 33 has a right arm 33b bent substantially at a right angle and extending forward. The right arm 33b has an upper surface with a distal end on which an engagement pin 35 is provided, and a leaf spring 36 is mounted so as to be located in the rear of the engagement pin 35. The leaf spring 36 is provided for holding the connecting portion 30. The engagement pin 35 is engaged with the engagement groove 30a of the connecting portion 30 of the embroidery frame 20 or the engagement groove 32a of the connecting portion 32 of the engraving support 21.

The movable arm 34 is formed so as to be bilaterally symmetric with the right arm 33b and has a proximal or rear end mounted on the left upper surface of the main part 24a of the frame holder 24 so as to overlap the surface. The movable arm 34 has an upper surface provided with an engagement pin 37 located on a distal end thereof. The upper surface of the movable arm 34 further has a leaf spring 38 which is located in the rear of the second engagement pin 37 and provided for holding the connecting portion 30 or 32. The engagement pin 37 is engaged with an engagement groove 30b of the connecting portion 30 of the embroidery frame 20 or an engagement groove 32b of the connecting portion 32 of the engraving support 21.

The movable arm 34 has a proximal end formed with an elongate guide groove 34a which is elongate in the right-left direction. A guide pin 39 is mounted on the upper surface of the main part 24a of the frame holder 24. The guide pin 39 is engaged with the guide groove 34a. As a result, the movable arm 34 is slidable in the right-left direction relative to the main part 24a of the frame holder 24. Furthermore, the main part 24a of the frame holder 24 is provided with a positioning and fixing mechanism (not shown) which selectively fixes the movable arm 34 at one of a plurality of predetermined positions. When the user operates the positioning and fixing mechanism, the position of the movable arm 34 in the right-left direction is changeable.

As the result of the above-described construction, the user attaches the embroidery frame 20 or the engraving support 21 to the frame holder 24 while the movable arm 41 is fixed to a suitable position according to the type of the embroidery frame 20 or the engraving support 21 to be attached, that is, the width L1, L2. In attachment of the embroidery frame 20, the connecting portions 30 of the embroidery frame 20 are inserted between the movable arm 34 and the leaf spring 38 and between the right arm 43 and the leaf spring 36 from the front respectively as exemplified in FIG. 6. The engagement hole 30b of the connecting portion 30 is then engaged with the engagement pin 37 of the right arm 33b, and the engagement groove 30a of the connecting portion 30 is engaged with the engagement pin 35 of the right arm 33b. As a result, the embroidery frame 20 is held by the frame holder 24 and moved in the X or Y direction by the transfer mechanism 18. The engraving support 21 can also be attached to the frame holder 24 in the same manner as described above.

A frame type sensor 40 is mounted on the X-direction carriage 23 for detecting the embroidery frame 20 or the engraving support 21 attached to the frame holder 24 based on a detected position of the movable arm 34, as shown in FIGS. 6 and 8. The frame type sensor 40 comprises a rotary potentiometer, for example, and has a detecting element which abuts a detected portion comprising an inclined surface provided on the movable arm 34, for example. The frame type sensor 40 changes a resistance value and accordingly an output voltage value according to variations in a rotational angle of the detecting element depending upon the position of the movable arm 34 with respect to the right-left direction.

An output signal generated by the frame type sensor 40 is supplied to a control circuit 41 which will be described later, as shown in FIG. 8. The control circuit 41 then determines or detects the frame type between the embroidery frame 20 and the engraving support 21. Accordingly, the frame type sensor 40, the control circuit 41 and the like constitute a detection unit which detects whether the engraving support 21 has been attached to the transfer mechanism 18.

In the embodiment, the multineedle embroidery sewing machine 1 can execute a normal embroidery sewing operation with the use of a workpiece cloth and six-color embroidery threads. The multineedle embroidery sewing machine 1 can further execute an engraving operation in which the engraving needle 10 is struck against the surface of the engraving workpiece W such as thick tracing paper in dots while the engraving support 21 is transferred in the X or Y direction by the transfer mechanism 18, whereby a desired photograph, illustration or character is engraved on the workpiece W. In execution of the engraving operation, as shown in FIG. 2, the engraving needle holder 11 holding the engraving needle 10 is attached to the needle bar No. 6, instead of the needle 9 as described above.

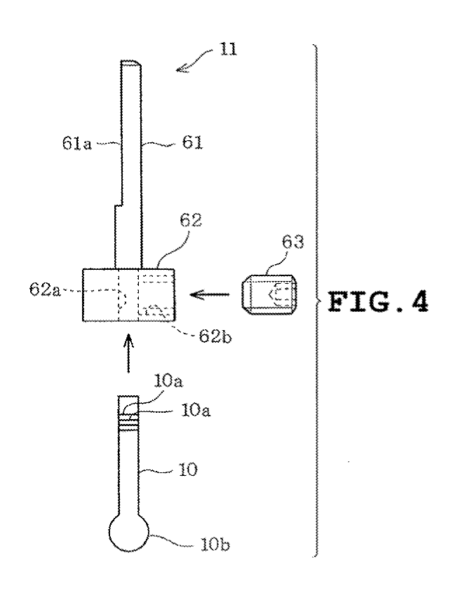

The engraving needle holder 11 includes a mounted part 61 made of a metal and formed into a vertically long rounded bar shape (cylindrical shape) and a horizontally long rectangular block-like supporting member 62 extending leftward from a lower end of the mounted part 61 as shown in FIGS. 3 and 4. The mounted part 61 and the supporting member 62 are formed integrally with each other. The mounted part 61 has an upper surface having the same thickness and the same shape as the handle of the upper portion of the needle 9. The mounted part 61 includes a D-cut portion 61a which is located at the rear side and formed into a D-cut shape which includes a flat portion in part of the circumferential surface. The user then inserts the mounted part 61 of the engraving needle holder 11 into the needle clamp 8a of the lower end of the needle bar 8 from below with the needle 9 being removed. On this occasion, the mounted part 61 is inserted until an upper end thereof abuts the stopper 8b, whereupon the engraving needle holder 11 is vertically positioned relative to the needle bar 8.

The engraving needle holder 11 can be mounted when the user then tightens up the setscrew 64. In this case, the aforementioned D-shaped cut portion 61a positions the engraving needle holder 11 relative to the needle bar 8. When it is assumed that the mounted part 61 is a completely round bar (cylindrical shape), there is a possibility that oscillation or the like resulting from the engraving operation may rotate the engraving needle holder 11 relative to the needle bar 8. Upon rotation of the engraving needle holder 11, the location of engraving by the engraving needle 10 would be displaced such that an engraved pattern formed by the engraving operation would be collapsed. In order that such a problem may be overcome, the engraving needle holder 11 is positioned relative to the needle bar 8 by the D-cut portion 61a to be fixed in position. The D-cut portion 61a thus serves as a positioning unit.

The supporting member 62 has an insertion hole 62a located at a left portion thereof and extending vertically therethrough. The supporting member 62 also has a screw hole 62b which is formed therethrough so as to extend from the front toward the rear thereby to reach the insertion hole 62a. A hexagon socket setscrew 63 is engaged with the screw hole 62b. The setscrew 63 has the same size as the setscrew 64 for fixing the needle 9 or the mounted portion 61.

The engraving needle 10 for parchment craft is made of a metal and formed into a needle shape (round bar shape) having a spherical portion 10b at a distal end thereof. The engraving needle 10 is inserted into the insertion hole 62a of the supporting member 62 from below thereby to be supported so that a vertical mounting height position of the engraving needle 10 as shown by arrow A in FIG. 3A is adjustable. The vertical mounting height position will hereinafter be abbreviated as “height position.” The setscrew 63 is tightened up after having been heightwise-positioned relative to the supporting member 62, whereupon the engraving needle 10 is attached. In this case, an upper part of the engraving needle 10 is provided with a plurality of reference lines 10a (four in the embodiment) serving as indexes of the height position. The reference lines 10a are arranged longitudinally at intervals of 0.2 mm. When viewing the reference lines 10a exposed above the supporting member 62, the user can adjust the height position of the engraving needle 10 at the intervals of 0.2 mm. The above-described supporting member 62, the screw hole 62b, the setscrew 63 and the like constitute an adjusting mechanism. The number of reference lines 10a provided on the engraving needle 10 and the interval between the reference lines 10a should not be limited to the foregoing ones.

Since the setscrews 63 and 64 have the common size as described above, the user can tighten and loosen both setscrews with a single tool such as a hex key, which can improve the usability of the engraving needle holder 10. Additionally, needle bar Nos. 1 to 5 are used for the embroidery sewing when the engraving needle holder 11 is attached to the needle bar No. 6.

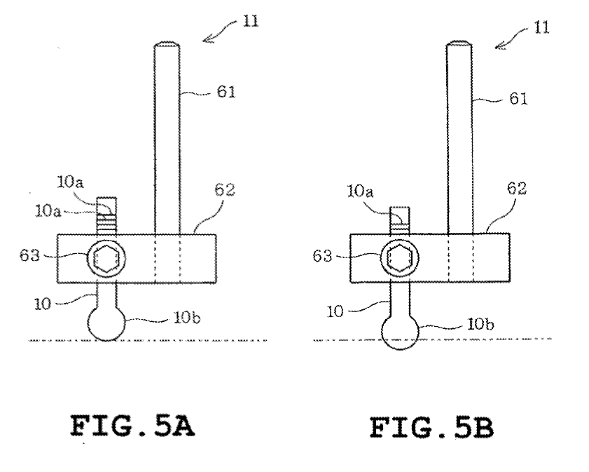

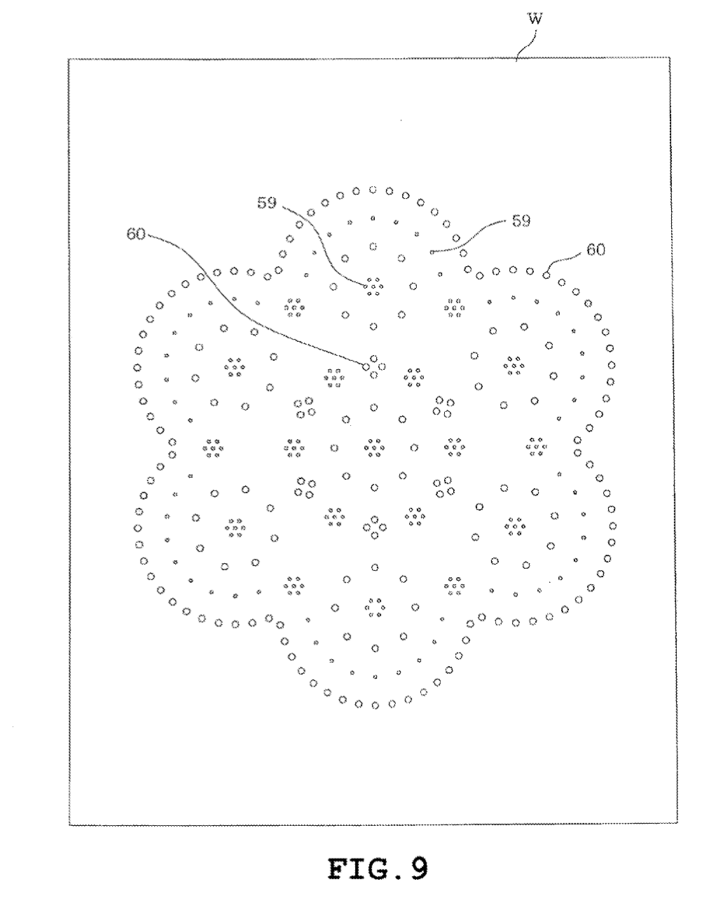

The distal or lower end of the engraving needle 10 includes the spherical portion 10b that is suitable for the engraving process such as the parchment craft. The engraving needle 10 is designed so as to abut the surface of the workpiece W held by the engraving support 21 when the needle bar 8 occupies a lowermost position (a bottom dead point). Accordingly, the engraving needle 10 is shorter than the sewing needle 9. The user can change the height position of the engraving needle 10 relative to the needle bar 8 thereby to change a depth of engraving or the degree of an engraved trace (the dent) formed on the surface of the workpiece W. As a result, the user can make a floral pattern on the thick tracing paper serving as the workpiece W with the engraving needle 10 as shown in FIG. 9. The user can obtain a smaller engraved trace 59 (having a diameter of approximately 1 mm) when the height position of the engraving needle 10 is set to an upper position, as shown in FIG. 5A. On the other hand, the user can obtain a larger engraved trace 60 (having a diameter of approximately 2 mm) when the height position of the engraving needle 10 is set to a lower position, as shown in FIG. 5B. Since the engraved traces 59 and 60 become cloudy, an engraved pattern is made by utilizing clouding.

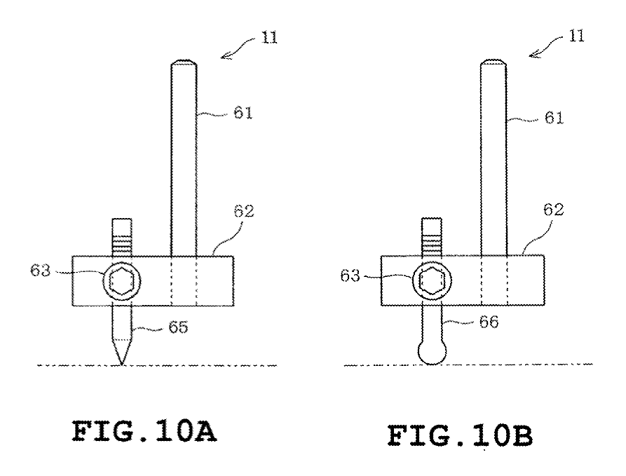

The user can prepare a plurality of types of engraving needles having different distal end shapes or different thicknesses, such as the engraving needle 65 having a pointed distal end as shown in FIG. 10A, the spherical engraving needle 66 with a smaller diameter as shown in FIG. 10B, or the like. In this case, the user selects and attaches an engraving needle with a desirable shape to the supporting member 62. Small holes can be made when the workpiece W is engraved by the engraving needle 65 with the pointed distal end. Furthermore, a plurality of engraving needle holders 11 with different types of engraving needles may be prepared.

FIG. 8 schematically illustrates an electrical arrangement of the multineedle sewing machine 1 with a control circuit 41 being focused around. The control circuit 41 serves as a control unit which controls an overall operation of the multineedle sewing machine 1. The control circuit 41 is mainly composed of a computer or a central processing unit (CPU). A ROM 42, a RAM 43 and a memory 44 are connected to the control circuit 41. The ROM 42 stores an embroidery sewing control program, an engraving process control program, various types of control data and the like. The memory 44 stores data of various types of embroidery patterns for embroidery sewing, engraving process data and the like.

Operation signals generated by various operation switches 45 on the operation panel are supplied to the control circuit 41. The control circuit 41 then controls the LCD 46. In this case, while viewing contents displayed on the LCD 46, the user operates the operation switches 45 so that the multineedle embroidery sewing machine 1 can execute a desired operation. A detection signal generated by the frame type sensor 40 of the transfer mechanism 18 is also supplied to the control circuit 41. The control circuit 41 then controls the sewing machine motor 16 via a drive circuit 48 and further controls the needle bar selecting motor 17 via a drive circuit 49. The control circuit 41 then controls the Y-direction drive motor 26 of the transfer mechanism 18 via a Y-direction drive circuit 50 and the X-direction drive motor 27 via an X-direction drive circuit 51. As a result, the frame holder 24 and accordingly the embroidery frame 20 or the engraving support 21 are moved.

Furthermore, the control circuit 41 executes the embroidery sewing control program to control the sewing machine motor 16, the needle bar selecting motor 17, the X- and Y-direction drive motors 27 and 26 of the transfer mechanism 18 and the like, based on the pattern data the user has selected from the pattern data for embroidery sewing stored on the memory 44, for example, so that an embroidery sewing operation is automatically executed on the workpiece cloth held by the embroidery frame 20. In this case, the aforementioned pattern data for embroidery sewing contains stitch data (transfer data) indicative of a needle location per stitch (an amount of movement of the embroidery frame 20 in the X- and Y-directions), color change data indicative of change of color of embroidery thread (the needle bar 8 to be driven), thread cutting data indicative of a thread cutting operation, sewing end data and the like, as well known in the art.

In the foregoing embodiment, upon execution of an engraving process control program, the control circuit 41 controls the sewing machine motor 16, the needle bar selecting motor 17, the X- and Y-direction drive motors 27 and 26 of the transfer mechanism 18 and the like, based on the engraving process data. As a result, the engraving process operation is automatically executable by the engraving needle 10 on the surface of the workpiece W held on the engraving support 21. In the engraving process operation, the needle bar No. 6 is selected, and the workpiece W is repeatedly moved to the following engraving point during upward movement of the needle bar No. 6 while the needle bar No. 6 (the engraving needle 10) is moved upward and downward. In this case, the engraving process data is mainly composed of a collective of engraving points per stitch (engraving locations) or transfer data indicative of amounts of movement of the workpiece W in the X- and Y-directions. The control circuit 41 executes the engraving process on condition that the frame type sensor 40 has detected attachment of the engraving support 21 to the frame holder 24. More specifically, in the case where attachment of the engraving support 21 has not been detected, the control circuit 41 prohibits start-up of the sewing machine motor 16 even when the execution of the engraving process has been instructed by the user.

The following describes the operation of the foregoing construction. The multineedle embroidery sewing machine 1 can execute the engraving operation in which a desired engraving pattern is formed on the workpiece W in the following manner, as well as the normal embroidery sewing operation. More specifically, a plurality of engraved traces (dents) or small holes is formed on the thick tracing paper used as the workpiece W. Thus, the parchment craft in which a decor is made can be carried out. In execution of the engraving operation, the user attaches to the needle clamp 8a of the needle bar No. 6 the mounting portion 61 of the engraving needle holder 11 holding the engraving needle 10. The user further attaches the engraving support 21 holding the workpiece W to the frame holder 24. The user then selects engraving process data of the desired engraving pattern, starting the engraving operation. In this case, the control circuit 41 controls the operation based on the detection by the frame type sensor 40 in startup of the sewing machine motor 16. More specifically, in starting the operation thereof, the control circuit 41 determines whether or not the engraving support 21 has been attached, based on an output signal generated by the frame type sensor 40.

When determining that the engraving support 21 has not been attached, the control circuit 41 controls the LCD 46 so that a message prompting correct attachment of the engraving support 21 is displayed on the LCD 46 and further controls the sewing machine motor 16 so that the motor 16 is not started up.

On the other hand, when determining that the engraving support 21 has been attached, the control circuit 41 executes an engraving operation by the engraving needle 10. In this case, the control circuit 41 drives the needle bar No. 6 to which the engraving needle holder 11 has been attached, by the needle bar selecting motor 17, while controlling the transfer mechanism to move the engraving support 21, namely, the workpiece W in the X- and Y-directions, based on the engraving data. As a result, the engraving needle 10 is caused to abut the surface of the workpiece W so that a plurality of engraved traces 59 and 60 according to the engraving data is formed on the workpiece W, whereby a predetermined engraved pattern including the engraved traces is formed.

The user loosens the setscrew 63 while the engraving needle holder 11 is attached to the needle bar 8. Thus, the user can adjust the height position of the engraving needle 10 while viewing the reference lines 10a. When matched with an upper reference line 10a, the engraving needle 10 occupies a lower position (see FIG. 5B). On the other hand, when matched with a lower reference line 10a, the engraving needle 10 occupies a higher position (see FIG. 5A). When the engraving needle 10 is located lower, larger (deeper) engraved traces 60 are formed on the workpiece W, whereas smaller (shallower) engraved traces 59 are formed on the workpiece W when the engraving needle 10 is located higher.

An engraved pattern as shown in FIG. 9 is composed of two types of traces, that is, smaller engraved traces 59 and larger engraved traces 60. In this case, engraving data includes engraving data for forming the smaller engraved traces 59, data for interrupting an engraving operation to instruct change in the height position of the engraving needle 10, and engraving data for engraving the larger engraved traces 60. These data are executed sequentially in the above-described order. Firstly, the user loosens the setscrew 63 to set the height position of the engraving needle 10 to a position as shown in FIG. 5A, thereafter tightening the setscrew 63 to fix the engraving needle 10. Subsequently, the user starts the engraving operation with the result that an engraved pattern comprising the smaller engraved traces 59 is formed on the workpiece W.

Upon completion of the smaller engraved traces 59, the engraving operation is once interrupted and instructions to change the height position of the engraving needle 10 (instructions to lower the engraving needle by 0.4 mm, for example) are displayed on the LCD 46. The user then loosens the setscrew 63 to change the height position of the engraving needle 10 to the position as shown in FIG. 5B, thereafter tightening the setscrew 63 to fix the engraving needle 10. Subsequently, the engraving operation is re-started so that the larger engraved traces 60 are formed on the workpiece W.

According to the multineedle embroidery sewing machine 1 provided with the engraving needle holder 11, the mounted part 61 is mounted to the needle clamp 8a located at the lower end of the needle bar 8, whereby the engraving needle 10 can be mounted to the needle bar 8. Accordingly, the engraving needle 10 can be attached to and detached from the needle bar 8 without detachment of the needle clamp 8a. Consequently, the engraving operation can be realized on the workpiece W in addition to the normal embroidery sewing operation on the workpiece cloth, whereby the multineedle embroidery sewing machine 1 can be used as an apparatus for executing an engraving process.

Furthermore, the engraving needle 10 is attached to the supporting member 62 provided on the lower end of the mounted part 61 so as to be positionally adjustable, and the height position of the engraving needle 10 relative to supporting member 62 can be adjusted by the adjusting mechanism comprising the setscrew 63. Accordingly, the user can easily adjust the height position of the engraving needle 10 relative to the needle bar 8 with the engraving needle holder 11 remaining attached to the needle bar 8. Consequently, when adjusting the height position of the engraving needle 10, the user can change the size of the engraved traces formed on the workpiece W by the engraving process or the size of the small holes. Furthermore, the user can also change among the engraving needles 10 with different distal end shapes.

Furthermore, since the reference lines 10a provided on the base of the engraving needle 10 are viewable, the user can accurately grasp and adjust the height position of the engraving needle 10. Accordingly, the user can accurately set the sizes of the engraved traces or small holes to be formed on the workpiece W.

Additionally, the user can position the mounting portion 61 relative to the needle clamp 8a with respect to the rotational direction using the D-cut portion 61a thereof. Consequently, the engraving needle holder 11 can be attached to the predetermined position relative to the needle bar 8.

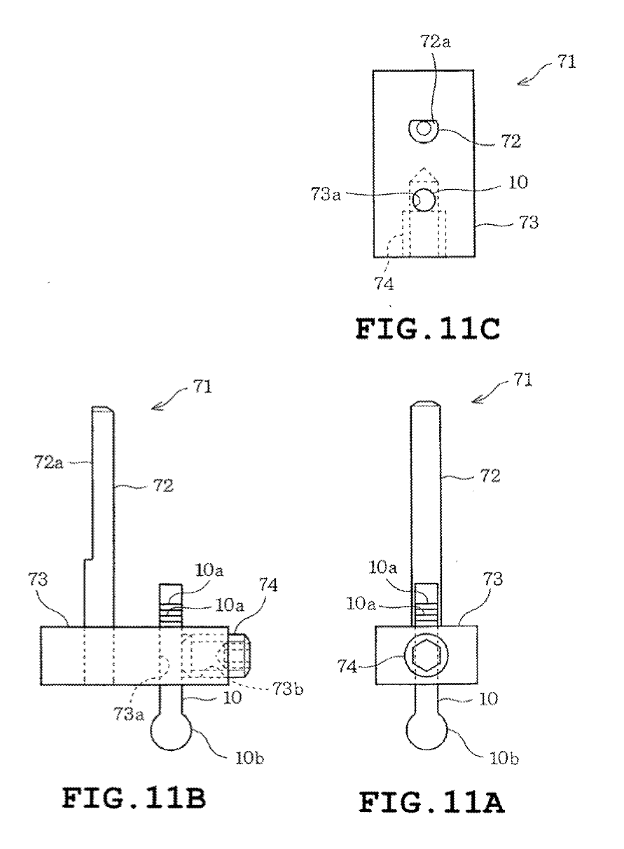

FIGS. 11A to 11C show the engraving needle holder 71 according to a second embodiment. The following describes the differences between the engraving needle holders 11 and 71 according to the first and second embodiments respectively. Although the engraving needle 10 is held so as to be located on the left of the mounted part 61 in the first embodiment, the engraving needle 10 is supported so as to be located in front of the needle bar 8 in the second embodiment.

The engraving needle holder 71 is provided with the mounted part 72 and the supporting member 73 as in the first embodiment. The mounted part 72 is also formed with the D-cut portion 72a as in the first embodiment. The supporting member 73 is a rectangular block extending frontward from the lower end of the mounted part 72.

The supporting member 73 has a through hole 73a which is located in a front portion thereof and extends vertically therethrough. The mounted part 72 has a screw hole 73b which extends rearward from a front portion thereof to reach the insertion hole 73a. A hexagon socket screw 74 is threadingly engaged with the screw hole 73b. The engraving needle 10 is supported by the setscrew 74 so that the height position of the engraving needle 10 is adjustable.

Since the supporting member 73 of the engraving needle holder 71 extends frontward as described above, the user can attach the engraving needle holder 71 to needle bar Nos. 1 to 5 as well as to needle bar No. 1. More specifically, the user can attach the engraving needle holders 71 provided with the respective engraving needles 10b having different height positions or shapes. Thus, since the engraving process data is configured to select a plurality of needle bars 8 and to execute the engraving process, various engraving processes with different sizes of engraved traces (dimples) or small holes can continuously be executed.

The foregoing embodiments should not be restrictive but may be modified or expanded as follows. Although the multineedle embroidery sewing machine 1 has six needle bars 8 in the foregoing embodiments, the sewing machine with a single needle bar 8 may be used, instead. Furthermore, the number of needle bars 8 provided in the multineedle embroidery sewing machine 1 may be 9, 12, etc. Thus, various changes may be made in an overall structure of the multineedle embroidery sewing machine 1, the structure of the transfer mechanism 18 (the carriage 19) and the structure of the engraving support 21.

Furthermore, various changes may be made in the structure of the engraving support 21. For example, the supporting member may comprise two front-rear divided members and may be configured so that the base of the engraving needle may be interposed between the divided members. Additionally, the adjusting mechanism may comprise a screw having a knob the user pinches to turn the screw.

Additionally, the engraving needle 10 may be provided with a plurality of notch grooves, instead of the reference lines 10a, and a plurality of annular protrusions engaging the respective notch grooves. As a result, the operation for position adjustment of the engraving needle 10 can be rendered easier.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. An engraving needle holder which mounts an engraving needle to a needle bar when an engraving process is executed for a workpiece by moving the engraving needle upward and downward by making use of drive of the needle bar provided on a sewing machine, the engraving needle holder comprising:
a mounted part which is mountable to a fixing part of a lower end of the needle bar into which a handle of the needle is inserted to be fixed, with the needle being removed;
a supporting member provided at a lower end side of the mounting part so that a base of the engraving needle is mounted thereto so as to be positionally adjustable; and
an adjusting mechanism which adjusts a mounting height position of the engraving needle relative to the supporting member.

2. The holder according to claim 1, wherein the base of the engraving needle has a reference line indicative of the mounting height position thereof and is supported by the supporting member while the reference line is in a visible state.

3. The holder according to claim 1, wherein the mounted part includes a positioning unit which positions the mounted part of the needle bar in a rotational direction.

4. The holder according to claim 2, wherein the mounted part includes a positioning unit which positions the mounted part of the needle bar in a rotational direction.

5. A sewing machine comprising:
a needle bar; and
an engraving needle holder which mounts an engraving needle to the needle bar when the engraving needle is moved upward and downward by making use of drive of the needle bar so that an engraving process is executed for a workpiece, the engraving needle holder including:
a mounted part which is mountable to a fixing part of a lower end of the needle bar into which a handle of the needle is inserted to be fixed, with the needle being removed;
a supporting member provided at a lower end side of the mounting part so that a base of the engraving needle is mounted thereto so as to be positionally adjustable; and
an adjusting mechanism which adjusts a mounting height position of the engraving needle relative to the supporting member.

6. The machine according to claim 5, wherein the base of the engraving needle has a reference line indicative of the mounting height position thereof and is supported by the supporting member while the reference line is in a visible state.

7. The machine according to claim 5, wherein the mounted part includes a positioning unit which positions the mounted part of the needle bar in a rotational direction.

8. The machine according to claim 6, wherein the mounted part includes a positioning unit which positions the mounted part of the needle bar in a rotational direction.
